(19) United States
(12) Patent Application Publication
(10) Pub. No.: US 2014/0028533 A1
(43) Pub. Date: Jan. 30, 2014

(54) ANTENNA REFLECTOR, OF DIAMETER GREATER THAN 1 M, FOR HIGH-FREQUENCY APPLICATIONS IN A SPACE ENVIRONMENT

(71) Applicant: Thales, Neuilly-sur-Seine (FR)

(72) Inventors: Florent LEBRUN, Mauzac (FR); Eric ARNAUD, Leguevin (FR)

(21) Appl. No.: 13/949,040

(22) Filed: Jul. 23, 2013

(30) Foreign Application Priority Data
Jul. 27, 2012 (FR) 12 02122

(51) Int. Cl. H01Q 15/16; H01Q 15/14

(52) U.S. Cl. CPC H01Q 15/16; H01Q 15/141
USPC 343/912; 156/60; 156/329; 156/242

(57) ABSTRACT

A antenna reflector compatible with high-frequency applications, i.e. applications using frequencies between 50 and 75 GHz, and suitable for use in a geostationary space environment, comprises a paraboloidal membrane comprising an active face allowing electromagnetic radiation to be reflected and a face opposite the active face. The opposite face of the reflector comprises ribs allowing the stiffness of the reflector to be increased, the ribs being placed on the opposite face in a way that forms a grid pattern between them.

### CROSS-REFERENCE TO RELATED APPLICATION

This application claims priority to foreign French patent application No. FR 1202122, filed on Jul. 27, 2012, the disclosure of which is incorporated by reference in its entirety.

### FIELD OF THE INVENTION

The invention relates to the field of geostationary telecommunication satellites comprising various passive antennae equipped with large reflectors. The invention is particularly intended for applications in very high-frequency bands such as the Ka and Q/V bands but also meets the lesser technological needs of lower frequency bands such as the C and Ku bands.

### BACKGROUND

The frequency band called the Ka band corresponds to frequencies between 26.5 and 40 GHz, i.e. wavelengths between 11.3 and 7.5 mm. The frequency band called the Q/V band corresponds to frequencies between 33 and 75 GHz, i.e. wavelengths between 9.1 and 3.3 mm.

The C and Ku frequency bands are currently widely used by operators. The Ka frequency band is in full development whereas Q/V-band solutions are only just emerging. The Ka frequency band is wider than the Ku frequency band i.e. it contains more frequencies. Thus, the Ka frequency band allows available capacity to be increased and therefore allows services to be provided at lower prices than with the Ku frequency band.

Moreover, beams generated in the Ka band are much more directional than beams generated in lower frequency bands, thus, since the energy is concentrated, the spectrum can be intensively reused in a geographically separate region.

The invention relates to a “passive on-board antenna” product composed of a source that emits radiation onto a reflector that is between 1.8 and 2.5 m in diameter. The use of this type of antenna in Ka- and Q/V-band applications requires the use of reflectors that:
have a very precise reflective profile. If the manufacturing tolerance is defined in terms of RMS, this type of Q/V-band application requires an RMS of about 60 microns, the RMS value being the average value of the standard deviation between the surface profile produced and the profile of the desired theoretical surface; and
exhibit a reflective profile that is very stable over a wide range of temperatures i.e. between −200° C. and +165° C. The deformation of the profile of the reflector under thermal load is quantified in terms of RMS, the maximum acceptable RMS value being 60 microns.

The use of this type of “on-board” reflector also implies additional requirements:
constraints in terms of mass, the maximum allowable mass is about 14 kg for a reflector that is 2 m in diameter;
the frequency of the primary resonant mode must be high enough that it does not couple to the main modes of the satellite. The specified requirement is for the antenna to have a primary mode, engaging more than 10% of the mass of the product, above 60 Hz; and
it must be easy to manufacture in order to limit production costs.

Different reflector technologies are commercially available.

A first widely used conventional technology is what is called “thick shell” technology. This technology is based on what is called a “sandwich” structure. A reflector produced in this technology comprises two membranes and what is commonly called a “spacer” structure located between the two membranes. The membranes comprise carbon and the “honeycomb” spacer comprises aluminium or CFRP (carbon fibre reinforced polymer). Carbon is used for its low expansion coefficient.

This design does not allow the specified 60 μm objective for reflective profile temperature stability to be met, it is therefore not suitable for use in the Q/V band.

A second technology called “Isogrid” technology is technically very effective.

The reflector comprises a membrane to which a stiffening lattice is fastened for the purpose of stiffening the reflector. The stiffening lattice is a reinforcing grid forming a triangular pattern called an “Isogrid” placed adjacent the first structure, the stiffening network being fixed to the membrane by adhesive bonding.

The glass transition temperature Tg of the adhesive used to join the stiffeners and the reflective membrane together mechanically is by nature incompatible with use at a temperature of +165° C. Specifically, this glass transition temperature is at best around +175° C. and it is therefore too near the high-temperature limit of the useful temperature range sought for this type of application. Moreover, the complexity of the assembly of the reinforcing grid makes this technology economically unattractive.

A product provided by EADS-CASA is composed of an assembly of thin elements. The active area of the reflector comprises a sandwich structure having the desired RF profile. A stiffening network composed of flat panels is associated with the active area of the sandwich structure, thereby stiffening it.

This product meets the requirements in terms of surface quality, in contrast it is relatively heavy. In addition, assembly of the various panels requires many man hours thereby making this product uncompetitive from an economic standpoint.

EADS Astrium provides a reflector produced in what is called Ultra Light Reflector (or ULR) technology; this type of reflector is particularly suitable for applications using frequencies ranging from the C band to the Ku band. This type of reflector is also very light. This product comprises two apertured carbon membranes, thereby making the ULR reflector insensitive to vibro-acoustic loads. However, a reflector produced in this technology is incompatible with Ka- or Q/V-band applications.

EADS Astrium is developing a second product, which is an evolution of the ULR concept. However, measurements of thermoelastic deformation have already demonstrated that this type of reflector will be incompatible with QV- and even Ka-band applications. Moreover, this reflector is not stiff enough as it has a resonant frequency much lower than the 60 Hz requirement.

### SUMMARY OF THE INVENTION

One aim of the invention is to provide a reflector for a telecommunications antenna as an alternative to existing technologies, which antenna reflector is compatible with high-frequency applications, is suitable for a space environment and requires fewer man hours to produce relative to known solutions.

According to one aspect of the invention, an antenna reflector is provided that is compatible with high-frequency applications, i.e. applications using frequencies between 50 and 75 GHz, and suitable for use in a space environment, which reflector comprises a paraboloidal membrane comprising an active face allowing electromagnetic radiation to be reflected and a face opposite the active face. The opposite face comprises ribs allowing the stiffness of the reflector to be increased, the ribs being placed on the opposite face and forming a grid pattern between them. The dimension of the rib perpendicular to the point where the rib is fastened to the membrane increases with distance from the edge of the reflector.

The ribs are arranged in a grid pattern the elementary cells of which are rectangular or square in shape. This type of pattern allows the specified stiffness objectives to be met while making assembly much easier, thereby making it possible to considerably reduce the number of man hours required and thus optimizing the economic competitiveness of the product. This embodiment allows the mass of the reflector to be decreased.

Preferably, the membrane comprises a single material comprising a carbon composite.

According to another variant of the invention, the ribs are surmounted by covering plates allowing the stiffness of the reflector to be increased, the covering plates are commonly referred to as “anti-tipping plates”. Advantageously, the covering plates comprise a single material comprising a carbon composite. Adding the covering plates prevents the ribs from tipping sideways.

Preferably, the membrane of the reflector has a diameter of between 1.8 and 2.5 m.

According to another aspect of the invention, a process for manufacturing a reflector such as described above is provided, in which the ribs are attached. Optionally, the ribs are attached by adhesive bonding. Preferably a silicone adhesive is used for this purpose.

A manufacturing process comprises:
a step of manufacturing a mould;
a step of producing the membrane on the mould;
a step of producing the ribs; and
a step of attaching the ribs directly to the opposite face of the membrane while it is still located on the mould.

Advantageously, the ribs are assembled via a system of notches that allows stiffening ribs that extend continuously from one edge of the reflector to the other to be used.

Preferably, the process comprises a step of producing and fastening covering plates to the ribs. Optionally the covering plates may be fastened in place by adhesive bonding using a silicone adhesive.

All the constituent elements of the reflector: membrane, ribs and covering plates, comprise a single material comprising a carbon composite, thereby ensuring optimal geometric stability in the temperature range defined above.

### BRIEF DESCRIPTION OF THE DRAWINGS

The invention will be better understood on studying a few embodiments described by way of completely non-limiting example, and illustrated in the appended drawings, in which:

FIGS. 1a, 1b and 1c show a side view, a top view and a bottom view, respectively, of a reflector according to one aspect of the invention;

FIG. 2 shows a notch system allowing the ribs to be assembled according to one aspect of the invention;

FIG. 3 shows covering plates allowing the stiffness of the reflector to be increased; and

FIGS. 4a, 4b and 4c show the main steps of the process for manufacturing the reflector, according to one aspect of the invention.

### DETAILED DESCRIPTION

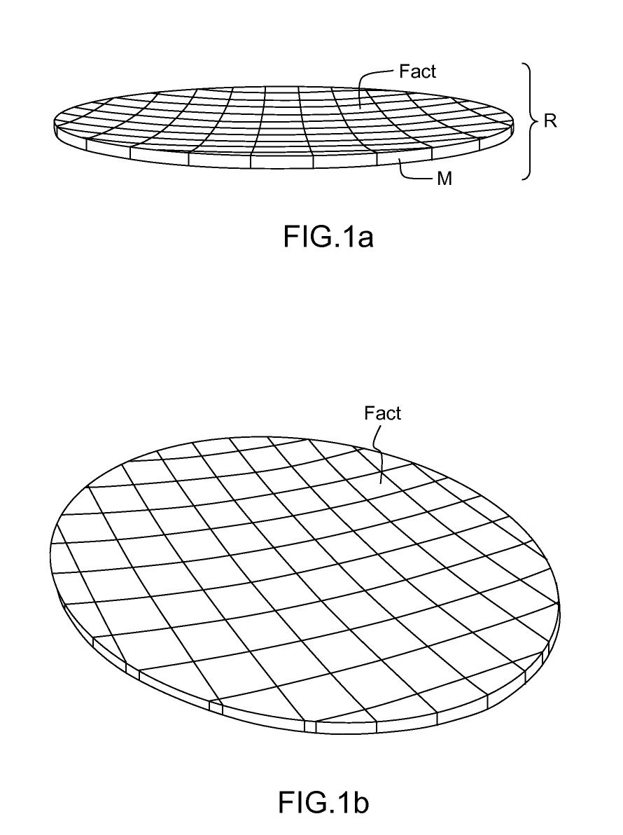

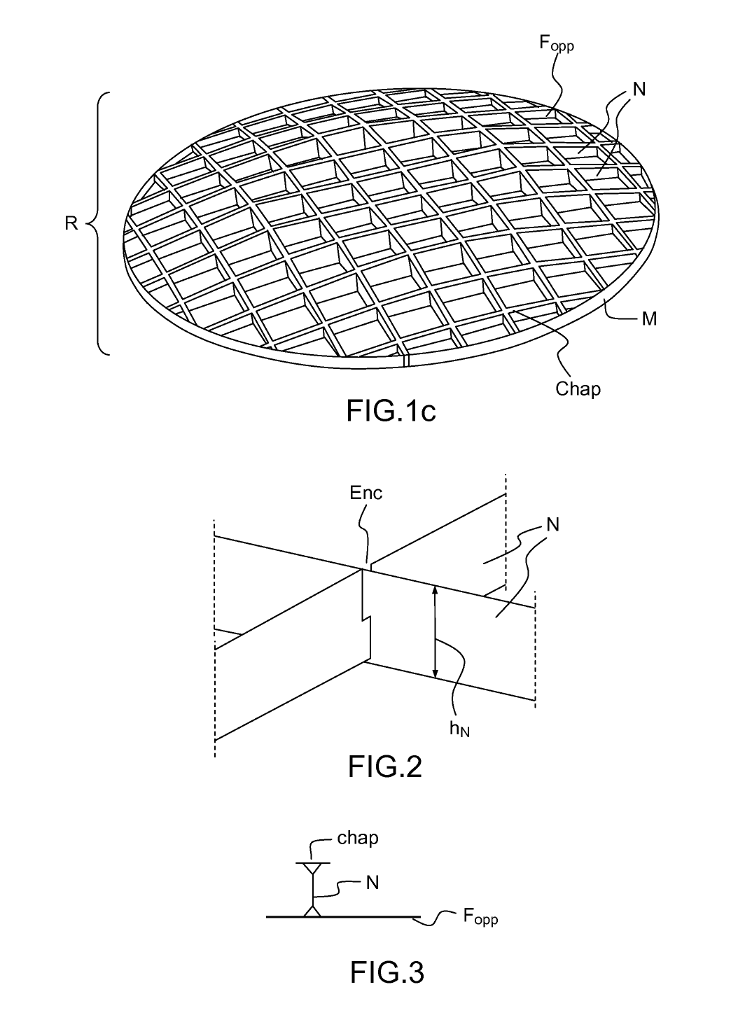

FIG. 1a illustrates a side view of an antenna reflector R. The antenna reflector R comprises a membrane M made of a carbon composite.

The membrane M comprises an active face Fact allowing electromagnetic radiation to be reflected and an opposite face Fopp; the active face Fact is concave and the opposite face Fopp is convex. Alternatively, the membrane M may comprise a flat opposite face Fopp.

In the present case, the membrane M is dome-shaped and comprises a convex active face Fact allowing electromagnetic radiation to be focused, and a concave opposite face Fopp.

FIG. 1b illustrates a top view of the reflector R corresponding to the active face Fact of the reflector R. It will be noted that the chequerboard patterns shown in FIGS. 1a and 1b are there only to make it easier to see the dome-shaped structure of the membrane M.

FIG. 1c shows a bottom view of the reflector R corresponding to the opposite face Fopp of the reflector R. In the present case, the opposite face Fopp of the reflector R has a convex shape.

Ribs N are placed on the opposite face Fopp of the reflector forming a grid pattern between them, the ribs N allow the membrane M to be stiffened.

According to one embodiment, the dimension of the rib perpendicular to the point where the rib is fastened to the membrane is constant. In other words, the height h_{N} of the ribs N is constant over the entire surface of the membrane M. This embodiment allows the manufacture of the ribs N to be automated and thus the cost of manufacturing the reflector R to be decreased.

Alternatively, the height h_{N} of the ribs N increases with distance from the edge of the reflector. In other words, the ribs N located near the edge of the reflector have a smaller height than the ribs N located near the centre of the reflector R, the stiffness of the stiffeners being greater at the centre of the reflector R than at its edges. This embodiment allows the mass of the reflector R to be decreased by decreasing the amount of material in the ribs N.

The ribs N are placed on the opposite face Fopp of the membrane M, the ribs forming between them a grid pattern of square or rectangular cells. FIG. 2 illustrates a notch system allowing the ribs N to be fixed together.

According to one aspect of the invention, the ribs N are assembled via a system of notches Enc. The ribs N are cut or milled in order to allow them to be fitted square to one another thus forming a grid pattern.

Fitting the ribs together to form a grid pattern of squares or rectangles simplifies the assembly process.

The ribs may be assembled using any other suitable assembly technique.

FIG. 3 illustrates the opposite face Fopp of the membrane M on which a rib N is placed, the rib N being surmounted by a covering plate Chap, also called an “anti-tipping” plate.

The covering plate Chap or anti-tipping plate is cut out from a sheet comprising a single material comprising a carbon composite, it is fixed to the membrane by adhesive bonding, by a system of clips or by any other method allowing it to be kept on top of the rib N.

The membrane M/rib N/covering plate Chap assembly forms an IPN or I-shaped profile allowing the stiffness of the reflector to be further increased.

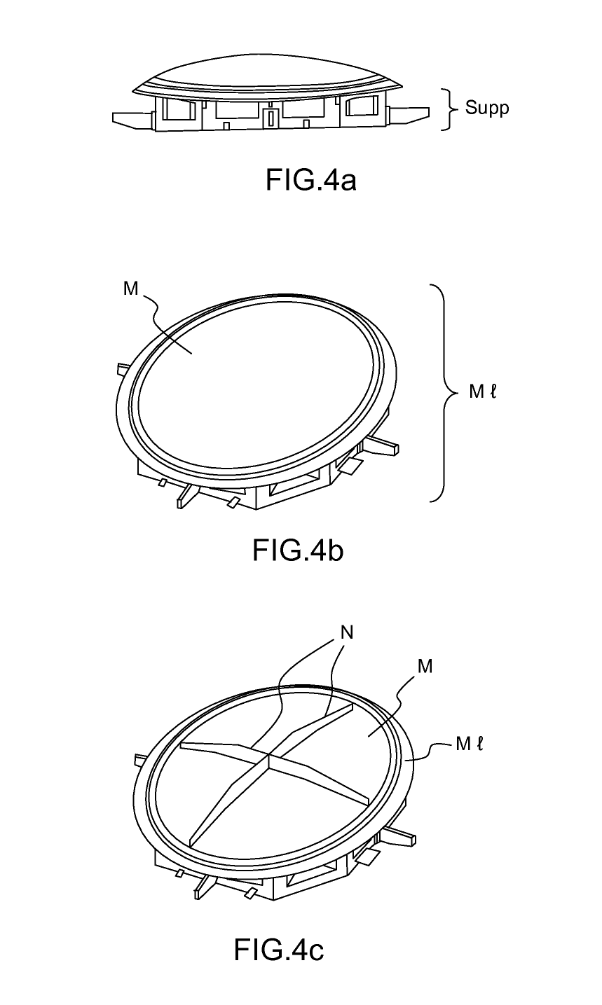

FIGS. 4a, 4b and 4c show the various steps of the process for manufacturing the reflector.

FIG. 4a illustrates a mould MI required to produce the reflector R. The mould MI comprises a stand Supp and a surface allowing the membrane M of the reflector R to be produced. The mould MI comprises Invar (registered trademark) or CFRP (carbon fibre reinforced polymer) having a low thermal expansion coefficient thus allowing contraction to be limited during cooling. In the present case, the surface of the mould MI is concave. FIG. 4b shows the mould MI with a membrane M in place on it. The membrane M comprises a monolithic carbon sheet, in the present case the membrane M is a monolithic CFRP sheet.

A process for manufacturing the membrane M consists in depositing a material comprising carbon pre-impregnated with an epoxy resin. This prepreg is polymerized in an oven. Alternatively, it is possible to deposit a woven or nonwoven material comprising non-impregnated carbon and to impregnate it using an infusion process followed by oven polymerization.

In the present case, the membrane M thus formed on the mould MI is concave, the exposed face corresponding to the opposite face Fopp of the membrane M of the reflector R.

According to a variant of the invention, the ribs are attached to the opposite face Fopp of the membrane M.

In the process for manufacturing the reflector R, the membrane M is not removed from the mould, the ribs are attached to the opposite face Fopp of the membrane while it is still in the mould. The ribs N are produced from monolithic carbon sheets. The ribs N are cut out from sheets using a water-jet cutting process or any other technique for cutting this type of material. In addition, the ribs N are cut in order to allow them to be assembled using the notch system described above.

According to one variant of the invention, the ribs are cut following the geometric profile of the membrane M. This notably allows this reflector technology to be applied to antennae the reflectors of which must have complex reflective profiles, composed of a dish associated with specific undulating variations.

FIG. 4c shows the mould MI with the membrane M in place on it and with ribs N attached to the membrane M in order to form a grid pattern. The ribs N are fixed to the membrane M by adhesive bonding, for example.

Alternatively, the mould MI allowing the membrane M of the reflector R to be produced may comprise ribs N on the surface intended to produce the membrane M. The membrane M formed using such a mould MI comprises ribs N allowing the reflector R to be stiffened.

In another production step, covering plates Chap or anti-tipping plates may be fixed to the ribs.

A reflector R produced in the proposed technology allows the necessary objectives for applications in frequency bands as high as the Q/V band to be met, this reflector having a mass lower than 14 kg for a 2 m diameter. Moreover, assembling the ribs N in a grid pattern allows many man hours to be saved making the proposed product more economically competitive than currently available solutions.

1. An antenna reflector compatible with high-frequency applications using frequencies between 50 and 75 GHz, and suitable for use in a geostationary space environment, comprises:
a paraboloidal membrane comprising an active face allowing electromagnetic radiation to be reflected and a face opposite the active face,
the opposite face comprising ribs allowing the stiffness of the reflector to be increased, and
wherein the ribs are placed on the opposite face in a way that forms a grid pattern between them, the dimension of the rib perpendicular to the point where the rib is fastened to the membrane increasing with distance from the edge of the reflector.

2. The reflector according to claim 1, wherein the membrane comprises a single material comprising a carbon composite.

3. The reflector according to claim 1, wherein the ribs are surmounted by covering plates allowing the stiffness of the reflector to be increased.

4. The reflector according to claim 3, wherein a covering plate comprises a carbon composite.

5. The reflector according to claim 1, wherein the membrane of the reflector has a diameter of between 1.8 and 2.5 m.

6. A process for manufacturing a reflector according to claim 1, wherein the ribs are attached.

7. The process according to claim 6, wherein the ribs are attached by adhesive bonding.

8. The process according to claim 7, wherein the adhesive used for the adhesive bonding is a silicone adhesive.

9. The process according to claim 6, further comprising:
manufacturing a mould;
a step of producing the membrane on the mould;
producing the ribs; and
attaching the ribs directly to the opposite face of the membrane while it is still located on the mould.

10. The process according to claim 9, wherein the ribs are assembled via a system of notches.

11. The process according to claim 10, further comprising a step of fastening the covering plates in place.
